(19) United States
(12) Patent Application Publication
(10) Pub. No.: US 2019/0085534 A1
(43) Pub. Date: Mar. 21, 2019

(54) TEMPORARY WATER RETENTION DEVICE

(71) Applicant: SARL LE PRIEURE, Moisy (FR)

(72) Inventors: Raphael LAME, Moisy (FR); Jean-Christophe GRIMARD, Cellettes (FR)

(73) Assignee: SARL LE PRIEURE, Moisy (FR)

(21) Appl. No.: 15/577,234

(22) PCT Filed: May 26, 2016
(86) PCT No.: PCT/EP2016/061933

§ 371 Date: Jan. 24, 2018

(30) Foreign Application Priority Data
May 26, 2015 (FR) 1554726

(51) Int. Cl. E03B 1/04; A01G 27/00; A01G 25/16

(52) U.S. Cl. CPC E03B 1/042; E03B 1/041; A01G 25/167; A01G 27/003; A01G 27/008

(57) ABSTRACT

Temporary water retention device (2) comprising: one or more water retaining tank(s) (21), forming a temporary water reservoir and comprising water inlet and/or outlet means, regulation means (23) designed to regulate the flow rate of water through the inlet and/or outlet means, a level sensor (25) configured to measure the level of water retained in the or one of the retaining tanks, and communication means (27) comprising: o a first communications interface designed to receive data from the level sensor, o a second communications interface interfacing wirelessly with a remote server, and o data processing means configured to process data received by the first interface and so that the communication means transmit processed data via the second communications interface.

### TECHNICAL FIELD

This concerns the technical field of water management. The invention relates more precisely to an assembly for controlling water retention, of rainwater for example, in roofing or on a terrace or at ground level for example.

### STATE OF THE ART

Because of the increasing water-proofing of urban ground and roofs, the management of rainwater has become a major problem.

As a matter of fact, rainwater cannot infiltrate into rain-proofed or on modern roofs. Most rainwater must be collected and treated. This collection has a financial cost (pipes, retention basins, water treatment plants), and an ecological cost since the water is soiled by numerous pollutants on its travel (waste, hydrocarbons, heavy metals, etc. . . .). Another problem resulting from the rain-proofing of ground is the increased risk of overflow of sanitary networks and flooding. During violent storms, greater and greater volumes of rainwater run-off, giving rise to a saturation of sewers and overflowing which bring pollutants back to the surface.

Roof tray assemblies, in particular revegetation trays, bring specific responses to these problems to the extent where they offer real management of rainwater. These assemblies enable management of the retention of rainwater by playing a buffer role (delay effect) during violent storms. These assemblies accordingly reduce the run-off coefficient. Current revegetation roof systems however do have some limitations. If the revegetation roofs significantly and temporarily reduce run-off, the coefficient could be reduced more, the control of their leakage rate is delicate.

Also, if these assemblies for roofs reduce the average annual run-off coefficient by around 50%, they do not ensure a systematic abatement of each rainy event. In fact, the run-off coefficient is not really controlled but varies substantially as a function of the characteristics of the rain event and of the hydric state of the revegetation roofing. Therefore, a revegetation roofing already saturated by previous rain will have a run-off coefficient almost equal to 1 and zero delay effect, which is reflected by an unreduced leakage rate and in all cases never constant.

Storage roofs ensure temporary retention of rainwater to be evacuated according to a certain leakage rate spread over time.

Documents EP 1044599 B1 and WO 2010/086369 A1 present elements for responding to the control requirements of rainwater from roofs.

But better management of water resources, for example for roofs or terraces or at ground level is preferred, particularly for managing situations where water is rare and necessary to the system, for example for proper development of plants.

### PRESENTATION

An aim of the invention is to propose a temporary water retention assembly for better management of water resources.

For this reason, a temporary water retention assembly is provided, comprising:
one or more water retention trays forming a temporary water tank and comprising water inlet and/or outlet means,
regulation means adapted to regulate the water flow via the inlet and/or outlet means,
a level sensor configured to measure the level of water retained in the or one of the retention trays, and
communication means comprising:
   a first communication interface adapted to receive data originating from the level sensor,
   a second wireless communication interface with a remote server, and
   data-processing means configured to process data received by the first interface and so that the communication means transmit processed data via the second communication interface.

The invention is advantageously completed by the following features, taken singly or in any of their technically possible combinations:
the communication means further comprise water level data-storage means;
the communication means comprise means for timestamping data originating from the level sensor;
the processing means are configured to control the regulation means as a function of a flow control;
the communication means comprise a third wireless communication interface adapted to communicate with the regulation means;
the flow control is developed by the processing means at least from data originating from the level sensor;
the flow control is received by the second wireless communication interface from the remote server;
the sensor is configured to automatically measure the water level at regular intervals;
the first communication interface is adapted to perform wireless communication, preferably local wireless communication, with the level sensor;
the level sensor is an ultrasound sensor;
a rainfall sensor, the first communication interface being adapted to receive data originating from the rainfall sensor;
a recorder/transmitter for collecting and communicating the measured values to a remote server and/or transmitting a control order (instruction) from the server to the regulating members/means;
at least one plate fitting into the or at least one of the retention trays, or is integral with the tray or one of the temporary water retention trays, to extend above the water tank;
the plate has at least one cell, such that the level sensor extends at least partially into the cell or such that the level sensor opens at the cell;
at least one revegetation tray comprising the plate, and a capillary rise wick arranged to enable water to rise from the temporary water retention tray underneath the plate to the revegetation tray;
the regulation means comprise a solenoid valve for blocking or for enabling circulation of water, for example by filling and/or emptying;
a revegetation wall, and irrigation means of the revegetation wall connected to the inlet and/or outlet means.

The invention also relates to a water management system comprising:
an assembly according to one of the preceding claims, and
a remote server configured to communicate with the second interface.

The invention according to this aspect is advantageously completed by the following features, taken singly or in any of their technically possible combinations:
the remote server is configured or the processing means are configured to calculate, for example as an instantaneous or accumulated value over a period of time, a rate or a volume of water rejected by the retention tray(s) from the processed data;
the processing means are configured to control the regulation means from a flow control, and the remote server is configured to:
   develop the flow control at least from the processed data received from the assembly, and
   send the flow control developed in this way to the assembly.

### DRAWINGS

Other aims, features and advantages will emerge from the following description given by way of illustration and non-limiting in reference to the drawings, in which:

FIG. 1 shows a view of a system according to an exemplary embodiment of the invention,

FIG. 2 shows communication means of an assembly of a system according to FIG. 1.

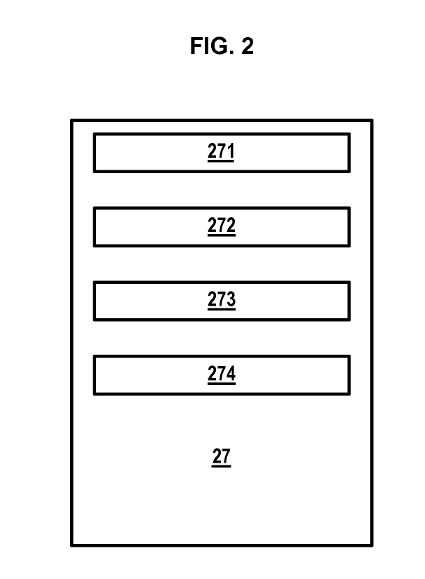

### DESCRIPTION

### General Structure of the System

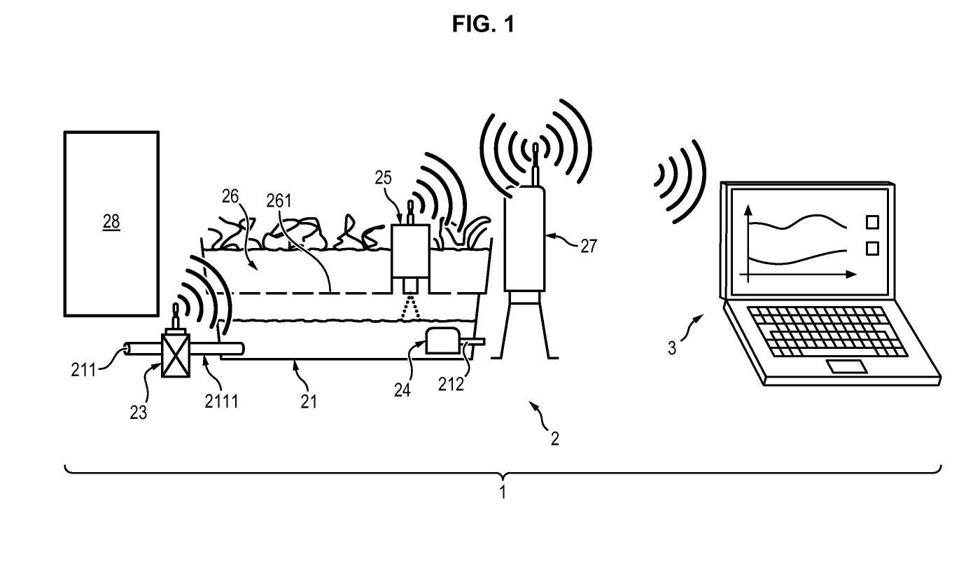

In reference to FIG. 1, there is disclosed an assembly 2 of temporary water retention, for example of temporary rainwater retention, for example of temporary water retention on roofing or terraces or at ground level, and a system 1 for managing water, comprising such an assembly 2, for example for managing rainwater, for example for managing water on roofing or terraces or at ground level.

The system 1 further comprises a remote server 3.

### Temporary Water Retention Assembly

### Water Retention Tray

The assembly 2 comprises at least one water retention tray 21, i.e., one or more water retention trays 21.

The at least one retention tray 21 forms a temporary water tank, i.e., it is adapted for temporarily storing a certain quantity of water. Each retention tray 21 comprises for example a bottom, for example a honeycombed bottom, and a side wall enclosing the bottom to form said temporary water tank.

The retention trays 21 of the assembly may for example be assembled together for example to cover a roofing area. For this purpose, each retention tray 21 may comprise one or more connectors. The connectors are for example hollow connectors. The connectors may for example enable alignment of the trays and/or free circulation of water between them, for example by forming fluid communication means between the retention trays 21.

The at least one retention tray 21 comprises water inlet and/or outlet means 211. The at least one retention tray 21 comprises for example water inlet means, i.e., means allowing water to flow in the tank. The at least one retention tray 21 comprises for example water outlet means, i.e., means letting water escape from the tank. The at least one retention tray 21 may comprise both water inlet means and water outlet means, which may be joined or separate. The inlet and/or outlet means 211 comprise for example a passage 2111 for circulation of water, for example a passage comprising an orifice passing through a wall of the retention tray 21, for example a conduit passing through a wall of the retention tray 21 or emerging from an open area of the retention tray 21.

The inlet means comprise a water inlet, for example. The outlet means comprise a water outlet, for example.

The inlet and/or outlet means 211 comprise one or more pipes for example. The inlet and/or outlet means 211 comprise assembled piping for example.

The inlet and/or outlet means 211 are for example disposed on and/or through a wall, for example the side wall, of the retention tray 21. The piping is for example assembled on and/or through a wall, for example the side wall, of the retention tray 21.

Each retention tray 21 may comprise dedicated inlet and/or outlet means 211. Alternatively, the retention trays 21 may comprise common inlet and/or outlet means 211, for example to place the retention trays 21 in fluid communication.

The at least one retention tray 21 may particularly comprise first inlet and/or outlet means 211 and second inlet and/or outlet means 212 separate from the first, the second inlet and/or outlet means 212 for example able to be regulated by a specific device which may be remote-controlled while the first inlet and/or outlet means 211 may be regulated by a specific device which may be remote-controlled. It is thus possible to combine different types of regulations.

The at least one retention tray 21 is for example a retention tray 21 of rainwater or irrigation water. The at least one retention tray 21 is for example disposed on roofing, or on a terrace, or at ground level.

The inlet means comprise and/or form for example a water sprinkling device, for example disposed on the periphery of the retention tray. Alternatively or in addition, the inlet means comprise and/or form for example one or more water supply conduits at a wall, for example a side wall of the retention tray.

The outlet means comprise and/or form for example a water discharge device, for example disposed on the periphery of the retention tray and/or at a wall, for example the side wall or the bottom of the retention tray.

### Regulation Means

The assembly 2 comprises regulation means 23 adapted to regulate the water flow via the inlet and/or outlet means 21.

The regulation means 23 for example set up a determined incoming or exiting flow of water. The regulation means 23 for example block or allow water circulation. The regulation means 23 may for example enable different levels of water circulation.

The regulation means 23 comprise for example a movable portion adapted between a position obstructing the inlet and/or outlet means 211 and a position enabling fluid circulation.

The regulation means 23 comprise for example a regulating member, for example a solenoid valve, for blocking or allowing water circulation, for example by filling and/or emptying the retention tray(s) 21.

In the event where the at least one retention tray 21 comprises separate first and second inlet and/or outlet means 211, the retention tray 21 may comprise first regulation means 23 associated to the first inlet and/or outlet means 211, and second regulation means 24 associated to the second inlet and/or outlet means 211, the different regulation means being for example configured to enable different regulations.

The assembly 2 may comprise at least one plate 261 fitting into the or at least one of the retention trays 21, or being integral with the tray or one of the retention trays 21, to extend above the water tank. The plate 261 may form part of another assembly disposed above the retention tray 21 and ensuring another function.

It may be a revegetation tray 26 comprising said plate 261, which may benefit from water retained for irrigation purposes. The assembly 2 may comprise at least one revegetation tray 26 comprising the plate 261, and preferably a capillary rise wick arranged to enable water to rise from the retention tray 21 underneath the plate 261 to the revegetation tray 26.

Alternatively, it may be a photovoltaic trayel which may benefit from the refreshing of its subsurface by evaporation of water retained for keeping its temperature at a high level of energy efficacy. It may also be a plate forming a support on which people may walk, in which case the stored water, apart from the advantages specific to storage, may decrease the ambient temperature and offer better comfort to people on the roof or, if the roofs are installed on a wide scale, fight against the phenomenon of urban heat islands, i.e., localized rises in temperatures and observed in an urban environment relative to temperatures in the surrounds or the corresponding region.

### Level Sensor

The assembly 2 comprises at least one level sensor 25 configured to measure the level of water retained in the at least one retention tray. The assembly 2 may comprise a plurality of retention trays 21, a single one being fitted with a level sensor 25, or some only being fitted with a level sensor 25, the retention trays 21 fitted with a sensor being for example distributed to be representative of all the retention trays 21 of the assembly. Even when roofing is sloping, it is thus possible to limit the number of level sensors 25 used.

The level sensor 25 is for example configured to measure automatically at regular intervals the water level. Alternatively, the level sensor 25 is configured to measure the level of water on demand.

The level sensor 25 is for example an ultrasound sensor.

In the event where the assembly comprises the plate 261, the plate 261 may have at least one cell, such that the level sensor 25 extends at least partially into the cell or such that the level sensor 25 opens at the cell. It is thus possible to improve the quality of measurement of the level sensor 25 by protecting the measuring area. This also maximizes the distance between the level sensor 25 and the surface of the water, to improve the measuring quality and be able to measure a wide range of water levels.

The level sensor 25 is for example integrated into the retention tray 25 or disposed above the retention tray 25. The level sensor 25 is for example arranged to be disposed above the surface of the water and/or vertically relative to the surface of the water.

The level sensor 25 is for example configured to measure the height and/or the variation of the level of water retained.

The plate 261 has for example at least one opening, for example a vertical opening, such that the level sensor 25 extends at least partially, for example entirely, above the opening or such that the level sensor 25 opens at the opening.

### Communication Means

The assembly 2 further comprises communication means 27.

The communication means 27 comprise a first communication interface 271 adapted to receive data originating from the level sensor 25. The first interface 271 may thus comprise at least one receiver.

The communication means 27 comprise a second communication interface 272 with a remote server 3. The second interface 272 may comprise at least one transmitter. The communication is for example wireless communication, for example radio communication, for example high-frequency radio communication, for example GSM and/or GPRS communication.

The communication means 27 comprise data-processing means 273. The processing means 273 are configured to process data received by the first interface. Processing may comprise processing data to enable their transmission by the second communication interface 272. The processing means 273 are configured so that the communication means 27 transmit processed data via the second communication interface 272.

It is thus possible to get information on the status of the retention trays remotely. This brings many advantages, such as monitoring the filling status of the retention trays, emptying rate, overflow count, behavior and performance of the assembly 2. It is also possible to set the behavior of the assembly disposed for example on roofing or a terrace relative to conditions of use, and therefore detect any malfunction of the assembly 2. Operation of the assembly is improved since it may be monitored with much more precision and it may be obvious if a maintenance operation is necessary.

The processing means 273 may be configured to control the level sensor 25 as a function of a level measurement control.

It is thus possible to control the level measurement and therefore decrease energy consumed by the level sensor 25.

The level measurement control may be developed by the processing means 273. It is thus possible for the assembly to act automatically and autonomously. Developing of the level measurement control may be such that the level sensor 25 is controlled to provide a measurement at regular intervals.

Alternatively, the level measurement control may be received by the second wireless communication interface 272 from the remote server 3. It is thus possible to control the behavior of the assembly remotely, for example using information previously obtained from the sensors and optionally other information. For example, if rain arrives in the near future, level measurement controls may be provided at high frequency to better monitor a period where the level of water risks evolving rapidly.

The first communication interface 271 may be adapted to perform wireless communication, preferably a local wireless communication, with the level sensor 25. It is thus possible to communicate with the level sensor 25 independently of its position relative to the communication means. The wireless communication is for example communication of Bluetooth or wifi type.

The processing means 273 are for example configured to develop a transmission control of processed data automatically and autonomously via the second communication interface 272. Developing the transmission control may be such that the remote server receives processed data at time intervals enabling consultation and analysis processing of data processed by the remote server.

Alternatively, the transmission control may be received by the second wireless communication interface 272 from the remote server 3, and may for example correspond to the level measurement control or correspond to a control of measurements already taken and stored. It is thus possible to control the behavior of the assembly remotely, for example using information previously obtained from sensors and optionally other information. For example, if rain is expected in the near future, transmission controls may be supplied at high frequency to better monitor a period where the level of water risks evolving rapidly.

The communication means may further comprise water level data-storage means. The communication means may form a recorder. This stores data so that aggregated information may be processed over time.

The communication means may comprise timestamping means for data originating from the level sensor. It is thus possible to perform monitoring over time of measured values and obtain enriched data.

The processing means 273 may be configured to control the regulation means 23 as a function of a flow control. The flow control may be a filling and/or emptying control.

It is thus possible to control supply and/or water outlet of the assembly, and therefore enable finer management of water retained by the assembly 2.

The flow control may be developed by the processing means at least from the data originating from the level sensor. It is thus possible for the assembly to set up a control adapted automatically and autonomously.

The processing means 273 comprise for example a processor and/or a printed circuit, configured to perform the functions described.

Alternatively, the flow control may be received by the second wireless communication interface 272 from the remote server 3. It is thus possible to control the behavior of the assembly remotely, using information obtained from the sensors and optionally other information. For example, if the retention trays are filled with water and rain is expected in the near future, a complete opening control of the regulation means may be provided for emptying the retention trays and let them effectively absorb future precipitation without overflowing or at least limiting the overflow.

The flow control and/or level measurement control, and/or transmission control and/or any other control received by the assembly or emitted by the assembly, or any group, for example assembly and/or suite, of such controls forming a control may focus on fighting against heat islands at the roof level, and therefore for example enable improvement of the yield from photovoltaic trayels by refreshing or on a wider scale the refreshing of an urban district over a period of hot weather. In the case of a revegetation roof, such a control may focus on preservation of plants. Also, such a control or such a group of controls may aim at reusing the water, for example for domestic use such as supplying a cistern, irrigation or sprinkling of gardens. Such a control or such a group of controls may also have technique uses, such as sprinkling or irrigation of a revegetation wall, or reusing wastewater for adapted uses.

In this way, the assembly 2 may further comprise a revegetation wall and irrigation means of the revegetation wall connected to the inlet and/or outlet means 211.

The control may be obtained by considering the specific local restrictions in terms of overload of the roofing, or control, limitation of water flow and rejected volumes, for example by programming such that the control aims to limit the reserve height of stored water and therefore optimization of the weight.

The communication means 27 may comprise a third communication interface 274, for example wireless, for example local, adapted to communicate with the regulation means 23. It is thus possible to control the regulation means 23 independently of their position relative to the communication means. The wireless communication is for example communication of Bluetooth or wifi type.

The processing means 273 are for example configured to control the regulation means 23 to adjust the level of water retained, for example to avoid overflow and/or desiccation of the temporary water tank.

### Rainfall Sensor

The assembly 2 may further comprise a rainfall sensor 28. The first communication interface 271 may be adapted to receive data originating from the rainfall sensor 28. It is thus possible to obtain information and control regulation of the retention trays 21 by further considering the local rainfall elements. In particular, knowledge of rainfall, coupled to the water level and to the information relative to the structure of the assembly, may set up the water flow at the inlet and/or outlet means 211.

In particular, the processing means 273 may be configured to calculate a magnitude such as a rate or volume of water rejected and/or accepted by the retention tray(s) 21 from the processed data. The magnitude calculated is expressed for example as an instantaneous value or accumulated over a period of time. It may be an arithmetic magnitude, i.e., it may express a water inlet or outlet. Rejection of water means for example water rejected by the inlet and/or outlet means, and/or water overflowing from the retention tray(s).

### System

The remote server 3 of the system 1 may be configured to communicate with the second interface 272.

The remote server 3 may further be configured to calculate a magnitude such as a rate or a volume of water rejected by the retention tray(s) 21 from the processed data. The magnitude calculated is for example expressed as an instantaneous or cumulated value over a period of time.

The processing means 273 may be configured to control the regulation means from a flow control, and the remote server 3 may be configured to develop the flow control at least from the processed data received from the assembly 2, and send the developed flow control to the assembly 2.

1. A temporary water retention assembly, comprising:
one or more water retention trays forming a temporary water tank and comprising a water inlet or outlet,
a regulating member adapted to regulate the water flow via the inlet or outlet,
wherein said temporary water retention assembly further comprises:
a level sensor configured to measure the level of water retained in the or one of the retention trays,
a first communication interface adapted to receive data originating from the level sensor,
a second communication interface with a remote server, and
a processor configured to process data received by the first interface and so that the second communication interface transmits processed data to the remote server.
the assembly comprising at least one plate fitting into the or at least one of the retention trays, or is integral with the tray or one of the retention trays, to extend above the water tank,
wherein the plate has at least one cell, such that the level sensor extends at least partially into the cell or such that the level sensor opens at the cell.

2. The assembly according to claim 1, wherein the processor is configured to control the regulating member as a function of a flow control.

3. The assembly according to claim 2, wherein the flow control is received by the second communication interface from the remote server.

4. The assembly according to claim 1, comprising a third wireless communication interface adapted to communicate with the regulating member.

5. The assembly according to claims 1, wherein the first communication interface is adapted to perform wireless communication, preferably local wireless communication, with the level sensor.

6. The assembly according to claims 1, wherein the level sensor is an ultrasound sensor.

7. The assembly according to claim 1, further comprising a rainfall sensor, the first communication interface being adapted to receive data originating from the rainfall sensor.

8. (canceled).

9. (canceled).

10. The assembly according to claim 1, wherein the plate has at least one opening, such that the level sensor extends at least partially above the opening or such that the level sensor opens at the opening.

11. A water management system comprising:
an assembly according to claim 1, and a remote server configured to communicate with the second interface.
